(19) United States
(12) Patent Application Publication
(10) Pub. No.: US 2026/0136129 A1
(43) Pub. Date: May 14, 2026

(54) ELECTRONIC DEVICE AND CONTROL METHOD THEREFOR

(71) Applicant: Samsung Electronics Co., Ltd., Suwon-si (KR)

(72) Inventors: Sooyeon PARK, Suwon-si (KR); Kyoungbo MIN, Suwon-si (KR); Hosang SUNG, Suwon-si (KR); Wonjun LEE, Suwon-si (KR); Seungdo CHOI, Suwon-si (KR)

(21) Appl. No.: 19/436,547

(22) Filed: Dec. 30, 2025

Related U.S. Application Data
(63) Continuation of application No. PCT/KR2024/006729, filed on May 17, 2024.

(30) Foreign Application Priority Data
Jul. 12, 2023 (KR) 10-2023-0090722
Jan. 15, 2024 (KR) 10-2024-0006155

(51) Int. Cl. H04R 1/10; H04R 1/08

(52) U.S. Cl. CPC H04R 1/1083; H04R 1/08; H04R 1/1016; H04R 2460/01

(57) ABSTRACT

An electronic device is provided. The electronic device includes a speaker, an outer microphone disposed in a direction opposite to a direction in which the speaker releases a sound, an inner microphone disposed in a direction in which the speaker releases a sound, memory, including one or more storage media, storing instructions, and one or more processors communicatively coupled to the speaker, the outer microphone, the inner microphone, and the memory, wherein the instructions, when executed by the one or more processors individually or collectively, cause the electronic apparatus to identify a noise signal based on an audio signal obtained through the inner microphone, input, to a first filter including a gain adaptation filter, a first audio signal obtained through the outer microphone, to identify a cancellation sound signal having a wavelength opposite to a wavelength of the identified noise signal, identify a first response characteristic and a second response characteristic corresponding to characteristics between the speaker and the inner microphone, input an error signal identified based on the identified noise signal and the identified cancellation sound signal to an adaptive module, update a coefficient of the gain adaptation filter based on the adaptive module excluding the second response characteristic, and control the speaker to output the identified cancellation sound signal.

### CROSS-REFERENCE TO RELATED APPLICATION(S)

This application is a continuation application, claiming priority under 35 U.S.C. § 365(c), of an International application No. PCT/KR2024/006729, filed on May 17, 2024, which is based on and claims the benefit of a Korean patent application number 10-2023-0090722, filed on Jul. 12, 2023, in the Korean Intellectual Property Office, and of a Korean patent application number 10-2024-0006155, filed on Jan. 15, 2024, in the Korean Intellectual Property Office, the disclosure of each of which is incorporated by reference herein in its entirety.

### BACKGROUND

### 1. Field

This disclosure relates to an electronic apparatus and a control method thereof. More particularly, the disclosure relates to an electronic apparatus capable of changing an active noise cancellation (ANC) filter value adaptively depending on a sound output environment and outputting a sound from which an ambient noise is blocked, and a control method thereof.

### 2. Description of Related Art

Sound output devices are electronic apparatuses that convert an electric signal to a soundwave and output the soundwave. Among the sound output devices, earbuds or headphones are manufactured as products that can be carried. Latest earbuds or headphones may support a noise cancellation function in that such earbuds or headphones are used in a noisy environment as well as a silent environment.

In the case of active noise cancellation (ANC), an ambient sound is received through a microphone, and a sound source in which the phase of waves with respect to the sound is reversed is output through a speaker, thereby blocking the ambient noise.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic apparatus and a control method thereof.

Additional aspects will be set forth in part in the description which follows and, in part, will be apparent from the description, or may be learned by practice of the presented embodiments.

In accordance with an aspect of the disclosure, an electronic apparatus is provided. The electronic device includes a speaker, an outer microphone disposed in a direction opposite to a direction in which the speaker releases a sound, an inner microphone disposed in a direction in which the speaker releases a sound, memory, including one or more storage media, storing instructions, and one or more processors communicatively coupled to the speaker, the outer microphone, the inner microphone, and the memory, wherein the instructions, when executed by the one or more processors individually or collectively, cause the electronic apparatus to identify a noise signal based on an audio signal obtained through the inner microphone, input, to a first filter including a gain adaptation filter, a first audio signal obtained through the outer microphone, to identify a cancellation sound signal having a wavelength opposite to a wavelength of the identified noise signal, identify a first response characteristic and a second response characteristic corresponding to characteristics between the speaker and the inner microphone, input an error signal identified based on the identified noise signal and the identified cancellation sound signal to an adaptive module, update a coefficient of the gain adaptation filter based on the adaptive module excluding the second response characteristic, and control the speaker to output the identified cancellation sound signal.

In accordance with another aspect of the disclosure, a method of controlling an electronic apparatus is provided. The method includes identifying a noise signal based on an audio signal obtained through an inner microphone disposed in a direction in which a speaker releases a sound, inputting, to a first filter including a gain adaptation filter, a first audio signal obtained through an outer microphone disposed in a direction opposite to a direction in which the speaker releases a sound, to identify a cancellation sound signal having a wavelength opposite to a wavelength of the identified noise signal, identifying a first response characteristic and a second response characteristic corresponding to characteristics between the speaker and the inner microphone, inputting an error signal identified based on the identified noise signal and the identified cancellation sound signal to an adaptive module, updating a coefficient of the gain adaptation filter based on the adaptive module excluding the second response characteristic, and controlling a speaker to output the identified cancellation sound signal.

In accordance with another aspect of the disclosure, one or more non-transitory computer-readable storage media storing one or more computer programs including computer-executable instructions that, when executed by one or more processors of an electronic apparatus, cause the electronic apparatus to perform operations are provided. The operations include identifying a noise signal based on an audio signal obtained through an inner microphone disposed in a direction in which a speaker releases a sound, inputting, to a first filter including a gain adaptation filter, a first audio signal obtained through an outer microphone disposed in a direction opposite to a direction in which the speaker releases a sound, to identify a cancellation sound signal having a wavelength opposite to a wavelength of the identified noise signal, identifying a first response characteristic and a second response characteristic corresponding to characteristics between the speaker and the inner microphone, inputting an error signal identified based on the identified noise signal and the identified cancellation sound signal to an adaptive module, updating a coefficient of the gain adaptation filter based on an error signal identified based on the adaptive module excluding the second response characteristic, and controlling a speaker to output the identified cancellation sound signal.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1A is a view provided to schematically explain an example in which an electronic apparatus is used according to an embodiment of the disclosure;

FIG. 1B is a view provided to schematically explain a control method of a conventional electronic apparatus according to an embodiment of the disclosure;

FIG. 2 is a block diagram illustrating a configuration of an electronic apparatus according to an embodiment of the disclosure;

FIG. 3 is a flowchart provided to explain a control method of an electronic apparatus according to an embodiment of the disclosure;

FIG. 4 is a view provided to explain a method of updating a coefficient of a gain adaptation filter according to an embodiment of the disclosure;

FIG. 5 is a flowchart provided to explain a method of updating a coefficient of a gain adaptation filter according to an embodiment of the disclosure;

FIG. 6 is a flowchart provided to explain a method of identifying an updated first signal according to an embodiment of the disclosure;

FIG. 7 is a flowchart provided to explain a method of identifying a cancellation sound signal according to an embodiment of the disclosure;

FIG. 8 is a flowchart provided to explain a method of identifying whether the user makes an utterance according to an embodiment of the disclosure;

FIG. 9 is a block diagram illustrating a configuration of an electronic apparatus according to an embodiment of the disclosure; and

FIG. 10 is a block diagram illustrating a specific configuration of an electronic apparatus according to an embodiment of the disclosure.

The same reference numerals are used to represent the same elements throughout the drawings.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Additionally, in a specific case, terms arbitrarily chosen by the applicant may be included in the terms used herein. In this case, the meanings of such terms are described in detail in corresponding descriptions of the disclosure. Accordingly, the terms used in the disclosure need to be defined based on the meanings thereof and particulars throughout the disclosure rather than simply names thereof.

In the disclosure, the expression “have”, “may have”, “include”, “may include” or the like, indicates the existence of a corresponding feature (e.g., a numerical value, a function, an operation or an element such as a part), and does not exclude the existence of an additional feature.

The expression at least one of A or/and B is to be understood as indicating any one of “A” or “B” or “A and B”.

The expression “1st”, “2nd”, “first”, “second”, or the like, used in the disclosure, may be used to refer to various elements regardless of their order and/or importance, and may be used merely to differentiate one element from another but not intended to limit the elements.

Based on one element (e.g., a first element) referred to as being “(operatively or communicatively) coupled with/to” or “connected with/to” another element (e.g., a second element), one element is to be understood as being connected to another element directly, or through yet another element (e.g., a third element).

In the disclosure, the term “include” or “comprised of” and the like specify the presence of stated features, numbers, steps, operations, elements, components or combinations thereof but do not imply the exclusion of the presence or addition of one or more other features, numbers, steps, operations, elements, parts or combinations thereof.

In the disclosure, the term “module” or “unit” may perform at least one function or operation, and be implemented by hardware or software or by a combination of hardware and software. Additionally, a plurality of “modules” or a plurality of “units” may be integrated into at least one module and be implemented by at least one processor (not illustrated) excluding a “module” or a “unit” that needs to be implemented by specific hardware.

In the disclosure, the term “signal” may include a soundwave-form signal as well as an electric signal, and in the case of an electric signal, the signal may be a digital signal as well as an analogue signal. For example, the expression “audio signal (or noise signal)” may mean that the signal outside an electronic apparatus means a soundwave (or electric wave) signal, and that the signal in an electronic apparatus means an electric signal, based on the position of the signal. Furthermore, signal processing and the like in an electronic apparatus, described hereafter, may be based on a signal processing method including analogue signal processing or a combination of analogue signal processing and digital signal processing as well as digital signal processing.

Additionally, in the disclosure, the term “filter” is to remove a specific component (e.g., a specific frequency area or a specific pattern), and the term may be a digital filter or an analogue filter.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

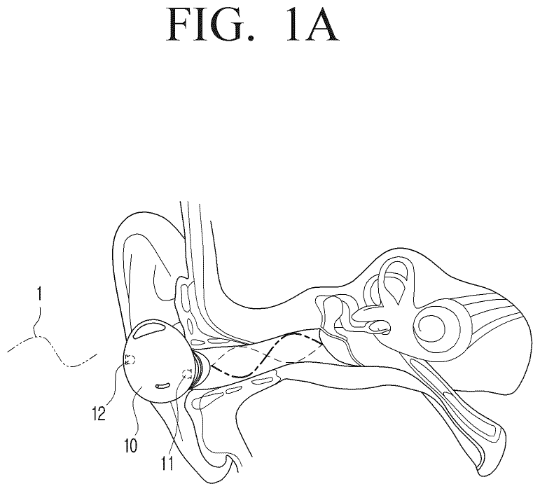

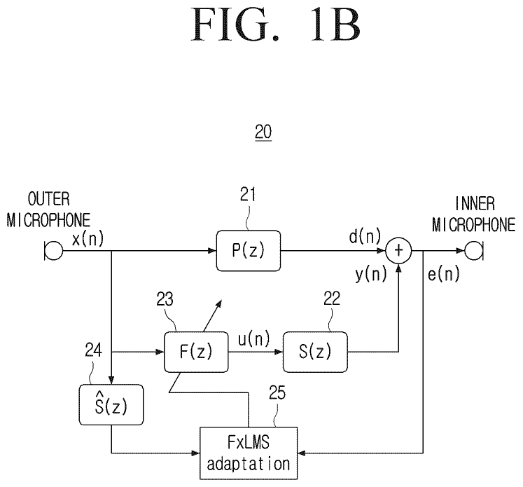

FIG. 1A is a view provided to schematically explain an example in which an electronic apparatus is used according to an embodiment of the disclosure.

Referring to FIG. 1A, an electronic apparatus 10 according to an embodiment is an electronic apparatus that converts an electric signal into a soundwave and outputs the soundwave. The electronic apparatus 10 may be earbuds or headphones. Hereafter, for convenience of description, the electronic apparatus 10 is described under the assumption that the electronic apparatus 10 is earbuds inserted into the ears of the user to be operated, but when implemented, the electronic apparatus 10 may be headphones, and may be an apparatus performing a function of removing noise only without performing a function of replaying a sound of contents stored outside or inside the electronic apparatus, or sound equipment that is not worn by the user for use or a combination of earbuds and a smartphone.

In the case where the user wears the electronic apparatus 10 on the ears, a speaker of the electronic apparatus 10 may face in the direction of the eardrum of the user, and a sound output from the electronic apparatus 10 is transmitted in the direction of the eardrum of the user. Accordingly, the user may hear the sound.

Where the electronic apparatus 10 is worn on the ears as described above, the electronic apparatus 10 shields the ears and supports a noise prevention function (or passive noise cancellation) to some degree. However, a specific ambient noise 1 may be transferred to the eardrum of the user, and the noise may interfere with the appreciation of contents.

The electronic apparatus 10 may identify a type of noise transferred to the eardrum of the user, and generate and output a cancellation sound signal corresponding to the identified type of the noise. The above-described cancellation sound signal may have a soundwave opposite to that of a noise signal, such that the two signals are removed based on wave interference.

Such an operation is referred to as active noise cancelling (ANC). The type of an ambient noise to be transferred to the eardrum of the user needs to be estimated rightly to remove a noise properly. The ANC method involves a technology in which an audio signal of a wavelength opposite to that of a noise (or a noise signal) heard in the ear is output to remove the noise, by using an audio signal obtained through an outer microphone 12 included in the electronic apparatus 10 and an audio signal obtained through an inner microphone 11 included in the electronic apparatus 10.

The above-described ANC method may be categorized into a feedforward (FF) ANC method in which a noise is collected through the outer microphone 12 and a feedback (FB) ANC method in which a noise is collected through the inner microphone 11, based on where a noise is collected. Alternatively, the ANC method may be categorized into a fixed filter method and an adaptive filter method in association with what filter value is applied to a collected noise in what way.

In an embodiment, the fixed filter method may involve using a fixed filter value (or a filter), and since a cancellation sound signal is generated only with the fixed filter value, may have an advantage of enabling a calculation with a low resource. However, in the case where the fixed filter value is used, since a response may not be made adaptively to a change in the shape of the ear canal of the user and/or a change in the wearing state, the noise removal performance may vary depending on the shape of the ear canal and/or the wearing state.

On the contrary, the adaptive filter method involves producing a filter value based on a calculation, and using the produced filter value to generate a cancellation sound signal, making it possible to maintain noise removal performance despite a change in the wearing state. However, there is a problem that an existing adaptive filter method requires a resource to produce the above-described filter and a parameter constituting the filter and is hardly applied to earbuds having a relatively low resource.

The objective of the disclosure is to describe various embodiments in which a small calculation amount is ensured and a reliable ANC is implemented, by implementing the adaptive feedforward ANC method only based on an adjustment of a gain value of the fixed filter.

FIG. 1B is a view provided to schematically explain a control method of a conventional electronic apparatus according to an embodiment of the disclosure.

Referring to FIG. 1B, a feedforward ANC model 20 according to an embodiment may include a first response characteristic 21, a second response characteristic 22, a feedforward filter 23, an estimated second response characteristic 24 and a Filtered-x Least Mean Squares (FxLMS) adaptive module 25.

The first response characteristic 21 indicates a characteristic of a sound transfer between a noise signal d(n) obtained through the inner microphone and an audio signal x(n) obtained through the outer microphone. The first response characteristic 21 may also be described as a characteristic of a sound transfer between the outer portion of the ear and the inner portion of the ear (the eardrum or a space where the eardrum is placed). The first response characteristic 21 may be less dependent on a sound direction but more dependent on a way of being worn by the user. For example, in the electronic apparatus 10 worn loosely (in the case where an electronic apparatus is worn not tightly or big tips are used or the like), more noise may come in through a gap between the tips and the ear than in the electronic apparatus worn tightly. The first response characteristic 21, as described above, may vary depending on the wearing state and the like. In particular, a difference of the first response characteristic 21 may occur further in a high-frequency band area of sounds.

The second response characteristic 22 indicates, for example, a characteristic of a sound transfer between the speaker and the inner microphone. The second response characteristic 22 may also be described as a characteristic of a sound transfer between the speaker and the inner portion of the ear. The second response characteristic 22 is also heavily dependent on the way of being worn. In an example, in the case where the user wears the electronic apparatus more tightly, a sound of the speaker may be transferred rightly to the inner portion of the ear, and in the case where the electronic apparatus is worn more loosely, a sound of the speaker may not be transferred rightly. In this context, the second response characteristic 22 may also vary depending on the wearing state. In particular, a difference of the second response characteristic 22 may occur further in a low-frequency band area of sounds.

The feedforward filter 23 needs to have a transfer characteristic for removing a noise signal transferred to the inner portion of the ear. In other words, the feedforward filter needs to have a transfer characteristic as shown in Equation 1 described hereafter such that a cancellation sound signal output from the speaker may have a wavelength opposite to that of a noise signal transferred to the inner portion of the ear.

$$F ( z ) = \frac{P ( z )}{S ( z )} \qquad Equation 1$$

In the case where the feedforward filter 23 has a transfer characteristic as shown in Equation 1 described above, the cancellation sound signal output from the speaker becomes x(n)*F(z)*S(z)=x(n)*P(z). Accordingly, the electronic apparatus 10 may identify the first response characteristic and the second response characteristic accurately, and operate at a filter value corresponding to the characteristics, to secure noise cancellation of high performance.

The first response characteristic 21 and the second response characteristic, as described above, may vary depending on the shape of the ear canal, the wearing state and the like. However, in the case where the feedforward filter value 23 is fixed despite a change in the first response characteristic 21 and the second response characteristic 22, the shape or size of the generated cancellation sound signal may not correspond to the noise signal, causing deterioration in noise cancellation performance. To maintain the performance regardless of the wearing state and the like, the adaptive filter method capable of estimating the wearing state and the like accurately, and generating a cancellation sound signal at a filter value corresponding to the wearing state was used.

An estimated second response characteristic 24 means, for example, a response characteristic in which a parameter value of a transfer function corresponding to an actual second response characteristic is predicted. As one example, transfer function information corresponding to the estimated second response characteristic 24 and information on the estimated second response characteristic 24 including parameter information of a transfer function may be pre-stored in the electronic apparatus 10 44, but not limited thereto.

The FxLMS adaptive module 25 is a module that updates transfer function information of the feedforward filter 23 and information on the feedforward filter 23 including parameter information of a transfer function, by using an audio signal x(n) in which the estimated second response characteristic is reflected and an error signal e(n). As one example, information on the feedforward filter 23 may include information on a coefficient corresponding to the feedforward filter. The FxLMS adaptive module 25 may update the coefficient corresponding to the feedforward filter based on input information.

In the case of an adaptive filter method, as an audio signal x(n) obtained through the outer microphone, a noise signal d(n) obtained through the inner microphone and a cancellation sound signal y(n) for canceling a noise are identified, the FxLMS adaptive module 25 may update the coefficient of the feedforward filter 23 by using an error signal e(n) corresponding to a difference between the noise signal d(n) obtained through the inner microphone and the cancellation sound signal y(n). The FxLMS adaptive module 25 may update the coefficient of the feedforward filter 23 in real time by using each of the error signal e(n) and the audio signal x(n) to which the estimated second response characteristic 24 is applied.

However, an existing adaptive filter method is hardly implemented. In detail, since a cancellation sound signal needs to be generated and output before an ambient noise reaches the eardrum of the user, rapid sampling of about 384 kHz is required for noise cancellation.

If an existing ordinary method is implemented with a finite impulse response (FIR) filter, a calculation with respect to about 32,768 tabs in the FIR filter is required. In other words, a high resource system is required to calculate about 32,768 tabs at a speed of the above-described sampling.

In the disclosure, suggested and described is a method of changing a filter value adaptively even with a low resource, by using a feedforward ANC model including a feedforward filter implemented as a fixed filter and a gain adaptive filter.

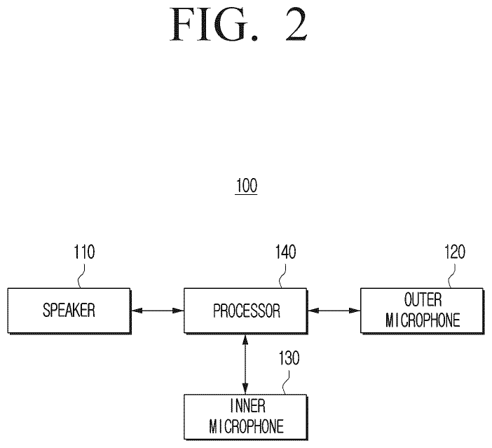

FIG. 2 is a block diagram illustrating a configuration of an electronic apparatus according to an embodiment of the disclosure.

Referring to FIG. 2, an electronic apparatus 100 may include a speaker 110, an outer microphone 120, an inner microphone 130 and one or more processors 140.

According to one embodiment, the speaker 110 may be comprised of a tweeter for replaying a sound in a high vocal range, a midrange for replaying a sound in an intermediate vocal range, a woofer for replaying a sound in a low vocal range, a subwoofer for replaying a sound in an extremely low vocal range, an enclosure for controlling resonance, a crossover network dividing an electric signal frequency input to the speaker based on each band, and the like.

According to another embodiment, the speaker 110 may output a sound signal to the outside of the electronic apparatus 100. The speaker 110 may output a multimedia replay, a recording replay, various notification sounds, a voice message and the like. The electronic apparatus 100 may include an audio output device such as a speaker 110, but may include an input device such as an audio output terminal. In particular, the speaker 110 may provide obtained information, information processed/generated based on the obtained information, a response result or an operation result with respect to a user voice and the like, in the form of a voice.

The outer microphone 120 may mean a module obtaining a sound and converting the sound into an electric signal, and may be a condenser microphone, a ribbon microphone, a moving coil microphone, a piezoelectric microphone, a carbon microphone, or a micro electro mechanical system (MEMS) microphone. The outer microphone may be implemented based on an omnidirectional method, a bidirectional method, a uni-directional method, a sub cardioid method, a super cardioid method, or a hyper cardioid method. According to one embodiment, the electronic apparatus 100 may include an outer microphone 120 and an inner microphone, and the outer microphone 120 may be a microphone placed relatively outside the body. As one example, the electronic apparatus 100 may obtain an audio signal including an ambient noise through the outer microphone 120. According to one embodiment, the outer microphone 120 may be disposed in a direction opposite to a direction in which the speaker 110 emits a sound.

The inner microphone 130 may mean a module obtaining a sound and converting the sound into an electric signal, and may be a condenser microphone, a ribbon microphone, a moving coil microphone, a piezoelectric microphone, a carbon microphone, or a micro electro mechanical system (MEMS) microphone. The inner microphone may be implemented based on an omnidirectional method, a bidirectional method, a uni-directional method, a sub cardioid method, a super cardioid method, or a hyper cardioid method. The inner microphone 130 may be a microphone placed relatively toward the body (or relatively close to the ear canal). As one example, the electronic apparatus 100 may obtain an audio signal including a noise occurring therein through the inner microphone 130. According to another embodiment, the inner microphone 130 may be disposed in a direction in which the speaker 110 emits a sound.

The one or more processors 140 (hereafter, a processor) may be electrically connected with the speaker 110, the outer microphone 120 and the inner microphone 130 to control the entire operations of the electronic apparatus 100. The processor 140 may be comprised of one processor or a plurality of processors. In detail, the processor 140 may execute at least one instruction stored in memory, to perform the operations of the electronic apparatus 100 according to the embodiments of the disclosure.

The processor 140 may be implemented as a digital signal processor (DSP) processing a digital image signal, a microprocessor, a graphics processing unit (GPU), an artificial intelligence (AI) processor, a neural processing unit (NPU), or a time controller (TCON). However, the processor is not limited thereto, and may include one or more of a central processing unit (CPU), a micro controller unit (MCU), a micro processing unit (MPU), a controller, an application processor (AP), or a communication processor (CP), an ARM processor, or may be defined as such terms. Additionally, the processor 140 may be implemented in the form of a system on a chip (SoC) with an embedded processing algorithm, large scale integration (LSI), or implemented in the form of an application specific integrated circuit (ASIC), a field programmable gate array (FPGA).

According to one embodiment, the processor 140 may identify a noise signal based on an audio signal obtained (or input) through the inner microphone 130. Alternatively, the processor 140, as one example, may also identify an audio signal input through the inner microphone 130 as a noise signal.

According to one embodiment, the processor 140 may input, to a first filter including a gain adaptation filter, a first audio signal obtained through the outer microphone 120, to identify a cancellation sound signal having a wavelength opposite to that of the identified noise signal. The gain adaptation filter is a filter amplifying the size of an input signal, and a coefficient of the gain adaptation filter is changed adaptively. As one example, the coefficient of the gain adaptation filter may be expressed in Equation 2 described hereafter.

$$g ( n + 1 ) = g ( n ) + μ {u}^{′} ( n ) e ( n ) \qquad Equation 2$$

Herein, g(n) is a coefficient of a gain adaptation filter. Herein, μ means a parameter corresponding to a step size of a filter. Herein, e(n) means an error signal that corresponds to a difference between a noise signal d(n) obtained through the inner microphone 130 and a cancellation sound signal y(n). Additionally, u(n) is a signal (or a first signal) that is obtained by allowing a first audio signal x(n) obtained through the outer microphone 120 to pass through the feedforward filter. Herein, u′(n) is a signal in which an estimated second response characteristic is reflected (or applied) in the first signal u(n) obtained by passing through the feedforward filter. As one example, information on the estimated second response characteristic including a coefficient corresponding to the estimated second response characteristic may be pre-stored in the memory. As one example, the first signal to which the estimated second response characteristic is applied may be produced based on Equation 3 described hereafter.

$${u}^{′} ( n ) = \hat{s} ( n ) ⋆ u ( n ) \qquad Equation 3$$

Herein, ŝ(n) is a coefficient corresponding to the estimated second response characteristic, and u(n) is a signal (or a first signal) that is obtained by allowing an audio signal x(n) obtained through the outer microphone 120 to pass through the feedforward filter.

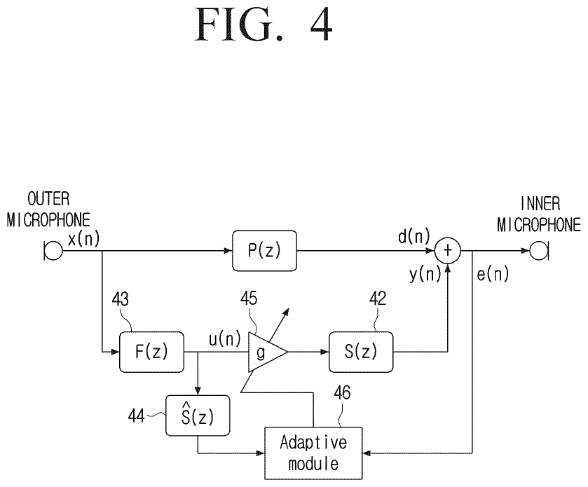

As one example, the processor 140 may input the first audio signal obtained through the outer microphone 120 to the first filter, to identify the cancellation sound signal y(n) for canceling a noise. As one example, the first filter may include a feedforward filter and a gain adaptation filter. The cancellation sound signal may be a signal having a wavelength opposite to that of a noise signal obtained through the inner microphone 130. As one example, the processor 140 may input the first signal to the gain adaptation filter to identify the cancellation sound signal. Detailed descriptions in relation to this are provided with reference to FIG. 4.

The processor 140 may control the speaker 110 to output the identified cancellation sound signal. As one example, as the cancellation sound signal is identified through the first filter, the processor 140 may control the speaker 110 to output the identified cancellation sound signal. As one example, the processor 140 may also output a content sound signal corresponding to a sound source content. For example, as a content sound signal corresponding to a sound source content is received from an external device (e.g., a smartphone) communicably connected with the electronic apparatus 100, the processor 140 may also output the identified cancellation sound signal together with the received content sound signal.

According to another embodiment, the processor 140 may identify a first response characteristic and a second response characteristic corresponding to characteristics between the speaker 110 and the inner microphone 130.

The processor 140 may input an error signal identified based on the identified noise signal and the identified cancellation sound signal to an adaptive module. The processor 140 may update the coefficient of the gain adaptation filter based on the adaptive module excluding the second response characteristic.

According to one embodiment, the processor 140 may update the coefficient of the gain adaptation filter based on the error signal identified according to the identified noise signal and the identified cancellation sound signal. As one example, the error signal means a signal corresponding to a difference between the noise signal d(n) obtained through the inner microphone 130 and the cancellation sound signal y(n). As one example, the coefficient of the gain adaptation filter may be updated based on Equation 2 described above.

For example, the processor may identify a first signal in which the estimated second response characteristic is reflected (or applied), based on the identified first signal. The processor may update the coefficient of the gain adaptation filter based on the applied first signal and error signal, by using Equation 3.

In the above example, a filter value may be changed adaptively even with a low resource, by using the feedforward ANC model including the feedforward filter implemented as a fixed filter and the gain adaptive filter.

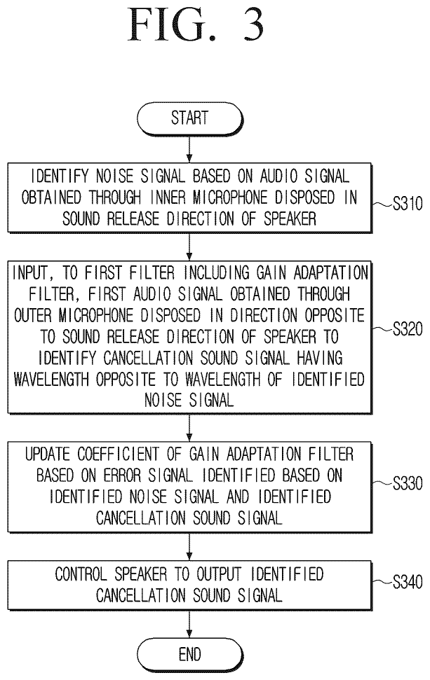

FIG. 3 is a flowchart provided to explain a control method of an electronic apparatus according to an embodiment of the disclosure.

Referring to FIG. 3, a control method according to an embodiment may identify a noise signal based on an audio signal obtained through an inner microphone 130 disposed in the direction where a speaker 110 releases a sound at operation S310.

Then the control method according to an embodiment may include inputting, to a first filter including a gain adaptation filter, a first audio signal obtained through an outer microphone 120 disposed in a direction opposite to the direction in which the speaker 110 releases a sound, to identify a cancellation sound signal having a wavelength opposite to that of the identified noise signal at operation S320. As one example, the processor 140 may identify a first signal by allowing the first audio signal obtained through the outer microphone 120 to pass through a feedforward filter. As the first signal is identified, the processor 140 may input the identified first signal to the gain adaptation filter, and based on a signal having passed through the gain adaptation filter, identify the cancellation sound signal. In this case, the cancellation sound signal may be a signal in which a second response characteristic is reflected.

The control method according to an embodiment may include updating a coefficient of the gain adaptation filter based on an error signal identified according to the identified noise signal and the identified cancellation sound signal at operation S330. As one example, the processor 140 may identify a signal corresponding to a difference between the noise signal and the identified cancellation sound signal as the error signal. The processor 140 may identify a first signal in which an estimated second response characteristic is reflected, based on the identified first signal and a coefficient corresponding to the estimated second response characteristic. Information on the estimated second response characteristic including the coefficient corresponding to the estimated second response characteristic may be pre-stored in memory. The processor 140 may update the coefficient of the gain adaptation filter based on the identified error signal and the first signal in which the estimated second response characteristic is reflected. For example, the processor 140 may update the coefficient of the gain adaptation filter by using Equation 3 described above.

Then the control method according to an embodiment may include controlling the speaker 110 to output the identified cancellation sound signal at operation S340.

FIG. 4 is a view provided to explain a method of updating a coefficient of a gain adaptation filter according to an embodiment of the disclosure.

Referring to FIG. 4, the first filter according to an embodiment may include a (fixed) feedforward filter 43 having a fixed coefficient and a gain adaptation filter 45. As one example, the processor 140 may input a first audio signal x(n) to the feedforward filter 43 to identify a first signal u(n).

According to an embodiment, the processor 140 may update a coefficient of the gain adaptation filter 45 based on the identified first signal u(n), a second response characteristic 42 corresponding to a characteristic between the speaker 110 and the inner microphone 130 and the identified error signal e(n). As one example, the processor 140 may update the coefficient of the gain adaptation filter 45 through an adaptive module 46.

In an example, in the case where the first signal u(n) is identified by inputting the first audio signal x(n) to the fixed feedforward filter 43, while a signal corresponding to a difference between the noise signal d(n) and the identified cancellation sound signal y(n) is identified as an error signal e(n), the processor 140 may input a first signal in which an estimated second response characteristic 44 is reflected and the error signal e(n) to the adaptive module 46 to update the coefficient of the gain adaptation filter 45, and as one example, the updated coefficient may be produced based on Equation 2 and Equation 3 described above.

According to one embodiment, the processor 140 may identify the cancellation sound signal based on the gain adaptation filter 45 of which the coefficient is updated. As one example, as the gain adaptation filter 45 is updated, the processor 140 may input the first signal u(n) to the updated gain adaptation filter 45, and apply the second response characteristic 44 to identify the cancellation sound signal.

According to one embodiment, the coefficient of the gain adaptation filter 45 may be updated based on a parameter corresponding to a step size of the gain adaptation filter 45. As one example, the coefficient of the gain adaptation filter 45 may be updated based on a parameter μ in a predetermined range according to Equation 2. As one example, the processor 140 may perform control such that the coefficient of the gain adaptation filter 45 is not diverged based on Equation 4 described hereafter.

$$0 ≺ μ ≺ min ( \frac{2}{{Φ}_{uu} ( {Ω}_{k} )} \frac{cos ( ∠ Ψ ( {Ω}_{k} ) )}{\vert Ψ ( {Ω}_{k} ) \vert} ) \qquad Equation 4$$

Herein, Φᵤᵤ(Ωₖ) means a power spectrum of a first signal u(n). Additionally, Ψ(Ωₖ) is a coefficient corresponding to a difference between a second response characteristic 42 and an estimated second response characteristic 44. As one example, Ψ(z) may be produced based on Equation 5 described hereafter.

$$\hat{s} ( z ) = Ψ ( z ) S ( z ) \qquad Equation 5$$

Herein, ŝ(z) means an estimated second response characteristic 44, and S(z) means a second response characteristic 42 (or an actual second response characteristic). Equation 5 reveals that in the case where the estimated second response characteristic 44 used for FxLMS differs from the actual second response characteristic 42, this affects a parameter value. In detail, a difference between the phase of the estimated second response characteristic 44 and the phase of the actual second response characteristic 42 needs to be within −90° [symbol] <Ψ<90°, and an increase in the size of an absolute value of Φᵤᵤ(Ωₖ) means a decrease in the size of the parameter.

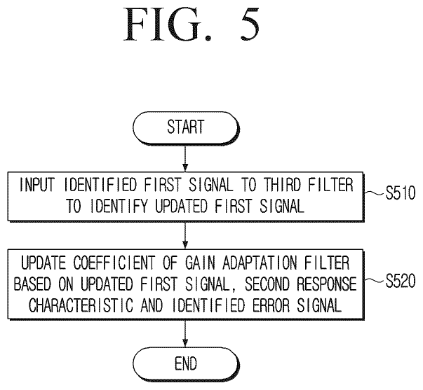

Ordinarily, since a band as a target of an ANC function is a relatively low band (or a low frequency band), noises having a relatively large wavelength become a target of the ANC function. Accordingly, in the case where a delay size of the second response characteristic 42 is relatively small, a restriction condition of −90° [symbol] <Ψ<90° may be avoided in a low band. In other words, in the case where the wavelength is long in the low band, a restriction condition with respect to a phase difference between the actual second response characteristic 42 and the estimated second response characteristic 44 may be avoided. Accordingly, even in the case where the estimated second response characteristic 44 is not filtered, the coefficient of the gain adaptation filter 45 may be converged without being diverged. As a result, a calculation amount may be decreased since a second response characteristic filtering calculation is not required, compared to an existing FxLMS method. A specific method of avoiding the above restriction condition is described in detail with reference to FIG. 5.

The processor 140 may update the coefficient of the gain adaptation filter 45 based on a function of a predetermined type. As one example, the processor 140 may update the coefficient of the gain adaptation filter 45 based on Equation 6 described hereafter.

$$g ( n + 1 ) = g ( n ) + μ sign ( {u}^{′} ( n ) ) sign ( e ( n ) ) \qquad Equation 6$$

According to Equation 6, g(n) is a coefficient of the gain adaptation filter 45. μ means a parameter corresponding to a step size of a filter. Herein, e(n) means an error signal corresponding to a difference between a noise signal d(n) obtained through the inner microphone 130 and a cancellation sound signal y(n), and u(n) means a first signal. Herein, u′(n) is a signal where an estimated second response characteristic 44 is reflected (or applied) in the first signal obtained by passing through the feedforward filter 43. According to Equation 6, the coefficient of the gain adaptation filter 45 may be updated based on a signal where a signum function is applied to the first signal in which the second response characteristic 42 is reflected, and a signal where a signum function is applied to an error signal. As one example, the signal where the signum function is applied to the first signal may be produced based on Equation 7 described hereafter.

$$sign ( {u}^{′} ( n ) ) = sign ( s ( n ) ⋆ u ( n ) ) ≅ sign ( u ( n ) ) \qquad Equation 7$$

According to Equation 7, s(n) means a second response characteristic 42. An output value of the signum function is limited to 1 or −1, and accordingly, even in the case where a relatively large signal comes in, the coefficient may be prevented from being increased rapidly. Additionally, a divergence restriction condition of FxLMS may be avoided, and a high robustness of the electronic apparatus 100 may be maintained. Along with this, a calculation amount may be much less than that in the case where a coefficient of the feedforward filter 43 is changed adaptively, leading to a decrease in battery consumption.

However, Equation 7 is not limited thereto, and Equation 6 and Equation 7 described above according to an embodiment may also be implemented as a sigmoid function.

FIG. 5 is a flowchart provided to explain a method of updating a coefficient of a gain adaptation filter according to an embodiment of the disclosure.

Referring to FIG. 5, the control method according to an embodiment may input the identified first signal to a third filter to identify an updated first signal at operation S510. As one example, the electronic apparatus 100 may further include the third filter outputting a signal within a predetermined first frequency band.

As an example, the predetermined first frequency band may be a low frequency band. The processor 140 may input the identified first signal to the third filter to identify a first signal of the low frequency band. As one example, the third filter may be implemented as a band pass filter or a low pass filter, but not limited thereto.

Ordinarily, since a band as a target of the ANC function is a relatively low band, noises having relatively large wavelengths become a target of the ANC function. Accordingly, in the case where a delay size of a second response characteristic is relatively small, a restriction condition (−90° [symbol] <Ψ [symbol] 90°) corresponding to the phases in Equation 4 and Equation 5 described above may be avoided in the low band. In other words, in the case where the third filter is implemented as a filter of a low frequency band as described above, a restriction condition corresponding to a phase difference between an actual second response characteristic and an estimated second response characteristic may be avoided.

Then the control method according to an embodiment may include updating the coefficient of the gain adaptation filter based on the updated first signal, the second response characteristic and the identified error signal at operation S520. As one example, the processor 140 may update the coefficient of the gain adaptation filter based on the first signal of the predetermined first frequency band, the second response characteristic and the identified error signal. For example, the processor 140 may use at least one of Equation 2 or Equation 6, to update the coefficient of the gain adaptation filter based on the first signal of the first frequency band, the second response characteristic and the identified error signal.

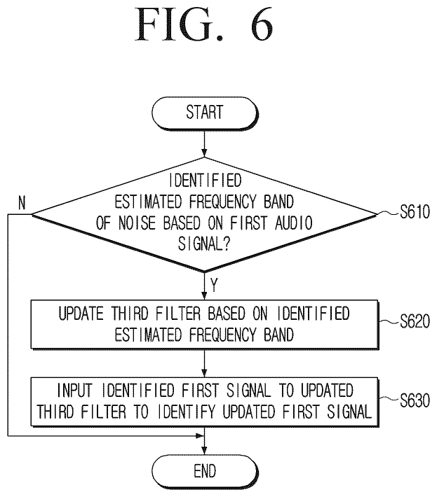

FIG. 6 is a flowchart provided to explain a method of identifying an updated first signal according to an embodiment of the disclosure.

Referring to FIG. 6, the control method according to an embodiment may include determining whether an estimated frequency band of a noise is identified based on a first audio signal at operation S610. As one example, as the first audio signal is obtained through the outer microphone 120, the processor 140 may estimate a frequency spectrum of the obtained first audio signal. For example, the processor 140 may identify a frequency band in which the first audio signal is included at a predetermined ratio or greater based on the estimated frequency spectrum as the estimated frequency band of the noise.

As the estimated frequency band of the noise is identified based on the first audio signal at operation S610: Y, the control method according to an embodiment may include updating the third filter based on the identified estimated frequency band at operation S620. As one example, as the estimated frequency band of the noise is identified, the processor 140 may update the predetermined first frequency band corresponding to the third filter to the identified estimated frequency band.

Then the control method according to an embodiment may include inputting the identified first signal to the updated third filter to identify the updated first signal at operation S630. As one example, as the predetermined first frequency band corresponding to the third filter is updated, the processor may input the identified first signal to the updated third filter to identify the updated first signal, and in this case, the updated third filter means a third filter in which the predetermined first frequency band is updated to the identified estimated frequency band.

Referring back to FIG. 2, in the case where ANC is implemented through the gain adaptation filter, there are concerns about abnormal operations with respect to an audio (a bone conduction sound or a bone conduction noise) generated from the body of the user such as user utterance. Ordinarily, in a bone conduction noise such as user utterance, the size of a signal in a low frequency band is greater than that in an ambient noise measured in an external microphone. This phenomenon is known as an occlusion effect. The occlusion effect means, for example, that a specific frequency is excessively amplified due to a block of the ear canal, or vocal cord vibration is generated around the eardrum based on lower jaw vibration, and a voice of the self or the other is heard in an echoed manner.

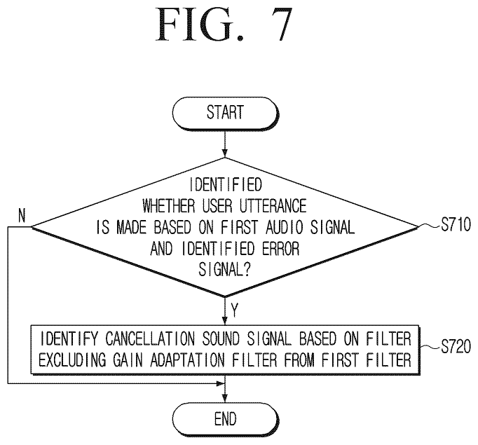

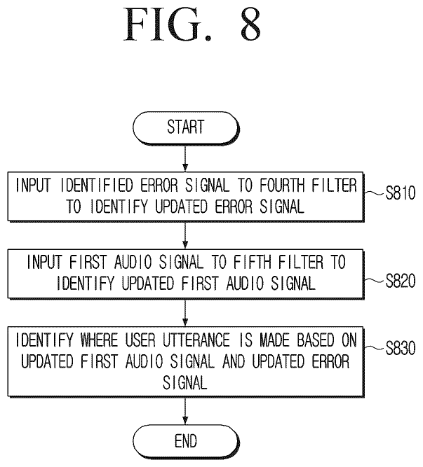

Since the bone conduction noise is not a signal caused by an ambient noise, there may be a case where a gain adaption operation is not performed normally such as excessive amplification of a bone conduction noise. However, a use utterance signal may be attenuated via a feedback ANC function corresponding to the inner microphone based on the occlusion effect, and accordingly, it is difficult to identify whether an utterance is made due to a difference between the size of a signal of the outer microphone and the size of a signal of the inner microphone. With reference to FIGS. 7 and 8 described hereafter, an embodiment in which to offset a user utterance attenuated based on feedback ANC, the attenuated user utterance is compensated to identify the user utterance is described. To limit a situation in which a gain adaptation operation is not performed normally because of the identified user utterance, described is an embodiment in which in the case where the user utterance is identified, a filter excluding the gain adaptation filter is used to identify the cancellation sound signal.

FIG. 7 is a flowchart provided to explain a method of identifying a cancellation sound signal according to an embodiment of the disclosure.

Referring to FIG. 7, a control method according to an embodiment may include determining whether an identification is made as to whether the user makes an utterance based on a first audio signal and an identified error signal at operation S710. As one example, as the first audio signal and the error signal are identified, the processor 140 may compare the size of the first audio signal and the size of the error signal to identify a signal corresponding to a user utterance. Detailed descriptions in relation to this are provided with reference to FIG. 8.

Then, as it is identified whether the user makes an utterance at operation S710: Y, the control method according to an embodiment may include identifying a cancellation sound signal based on a filer excluding a gain adaptation filter out of a first filter at operation S720. As one example, as the signal corresponding to the user utterance is identified, the processor 140 may control the gain adaptation filter to stop the gain adaptation filter from operating. The processor 140, for example, may identify, as the cancellation sound signal, a signal to which a second response characteristic is applied, as a signal not having passed through the gain adaptation filter, among first signals having passed through a feedforward filter.

FIG. 8 is a flowchart provided to explain a method of identifying whether the user makes an utterance according to an embodiment of the disclosure.

Referring to FIG. 8, a control method according to an embodiment may include inputting an error signal to a fourth filter to identify an updated error signal at operation S810. As one example, the electronic apparatus 100 may further include the fourth filter compensating the input signal. As one example, the fourth filter may be a feedback ANC compensation filter capable of compensating ANC attenuation, to offset a user utterance attenuated by feedback ANC. As one example, the processor may input the error signal to the fourth filter, to identify an updated error signal. The updated error signal may be a signal of which the signal corresponding to the user utterance is compensated.

Then the control method according to an embodiment may include inputting the identified first audio signal to a fifth filter to identify an updated first audio signal at operation S820. As one example, the electronic apparatus 100 may further include the fifth filter outputting a signal within a predetermined second frequency band. As one example, the fifth filter may be a band pass filter allowing a signal of a main frequency band (e.g., 50-1000 Hz) of an utterance signal and feedback ANC to pass through, but not limited thereto. As an example, the predetermined second frequency band may be a main frequency band (e.g., 50-1000 Hz) of the feedback ANC, but not limited thereto. As one example, the processor may input the identified first audio signal to the fifth filter to identify an updated error signal. Herein, the updated first audio signal may be a first audio signal of the predetermined second frequency band.

Then the control method according to an embodiment may include identifying whether the user makes an utterance based on the updated first audio signal and the update error signal at operation S830. As one example, the processor may identify whether the user makes an utterance by using the first audio signal of the predetermined second frequency band and the error signal of which the signal corresponding to the user utterance is compensated.

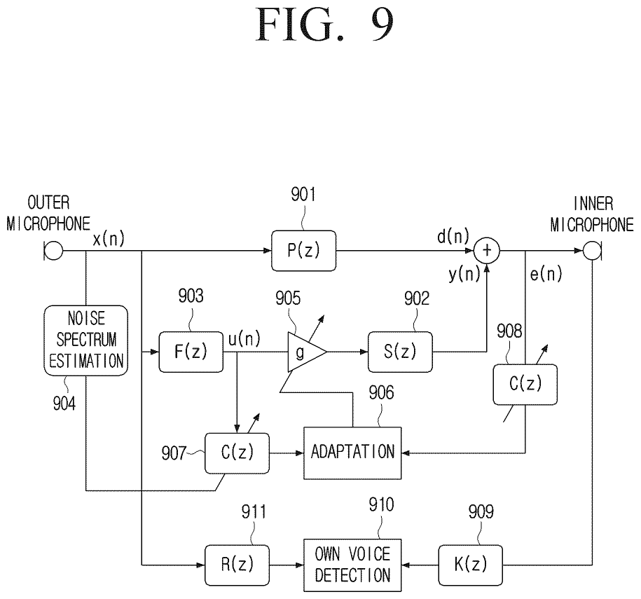

FIG. 9 is a block diagram illustrating a configuration of an electronic apparatus according to an embodiment of the disclosure.

Referring to FIG. 9, according to one embodiment, an ANC model 900 included in the electronic apparatus 100 may include a first response characteristic 901, a second response characteristic 902, a feedforward filter 903, a noise spectrum estimation module 904, a gain adaptation filter 905, an adaptive module 906, a plurality of third filters 907 and 908, a fourth filter 909, a user utterance sensing module 910, and a fifth filter 911. Among the above elements, the first response characteristic 901, the second response characteristic 902, the feedforward filter 903, the gain adaptation filter 905, the fourth filter 909 and the fifth filter 911 are described above, and accordingly, the noise spectrum estimation module 904, the adaptive module 906, the plurality of third filters 907 and 908, and the user utterance sensing module 910 are described hereafter.

The ANC model 900 may include the noise spectrum estimation module 904. The spectrum estimation module 904 is a module estimating a frequency band of an input audio signal. As one example, as a first audio signal x(n) is obtained through the outer microphone 120, the processor 140 may input the obtained first audio signal to the spectrum estimation module 904 to identify a frequency spectrum of the first audio signal. As one example, the processor 140 may estimate a noise spectrum based on the estimated frequency spectrum of the first audio signal. The processor 140, for example, may identify a frequency band in which the first audio signal is included at a predetermined ratio or greater based on the estimated frequency spectrum as an estimated frequency band of a noise.

According to another embodiment, the ANC model 900 may include a plurality of third filters outputting a signal within a predetermined first frequency band. As one example, the third filters may be implemented as a band pass filter or a low pass filter. The processor 140 may input an identified first signal u(n) to any one 907 out of the third filters to identify a first signal within the predetermined first frequency band. Alternatively, the processor 140 may also input an error signal e(n) to the other 908 out of the third filters to identify an error signal within the predetermined first frequency band.

According to one embodiment, the ANC model 900 may include an adaptive module 906. As one example, the processor 140 may update a coefficient of the gain adaptation filter 905 through the adaptive module 906. The processor 140, for example, may input the first signal within the predetermined first frequency band and the error signal within the predetermined first frequency band to the adaptive module 906 to update the coefficient of the gain adaptation filter 905.

The ANC model 900 may include a user utterance sensing module 910. The user utterance sensing module 910 is a module sensing whether a user utterance is present in an audio signal. As the first audio signal and the error signal are identified, the user utterance sensing module 910 may compare the size of the first audio signal and the size of the error signal to identify a signal corresponding to the user utterance. As one example, the processor 140 may input the error signal to the fourth filter to identify an updated error signal, and input the identified first audio signal to the fifth filter to identify an updated first audio signal. The processor 140 may input the updated first audio signal and the updated error signal to the user utterance sensing module 910 to identify whether a user utterance is present within the first audio signal obtained from the outer microphone.

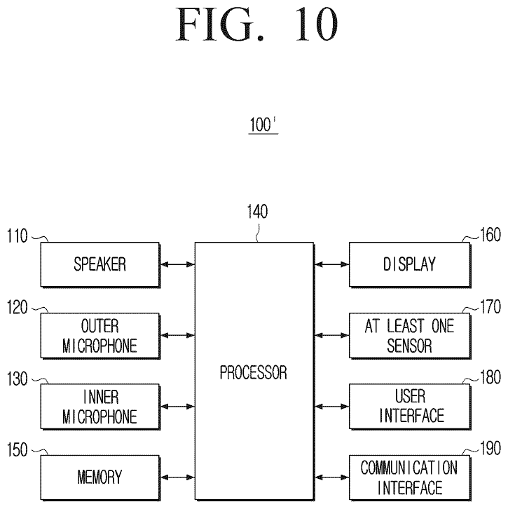

FIG. 10 is a block diagram illustrating a specific configuration of an electronic apparatus according to an embodiment of the disclosure.

Referring to FIG. 10, an electronic apparatus 100′ may include a speaker 110, an outer microphone 120, an inner microphone 130, one or more processors 140, memory 150, a display 160, at least one sensor 170, a user interface 180 and a communication interface 190. Among the elements illustrated in FIG. 10, detailed descriptions of elements overlapping the elements illustrated in FIG. 2 are omitted.

The memory 150 may store data required for various embodiments. The memory 150 may be implemented in the form of memory embedded in the electronic apparatus 100′, or in the form of memory detachable from the electronic apparatus 100′ depending on a data storage purpose. For example, in the case of data for driving the electronic apparatus 100′, the data may be stored in the memory embedded in the electronic apparatus 100′, and in the case of data for an expansion function of the electronic apparatus 100′, the data may be stored in memory detachable from the electronic apparatus 100′.

The memory embedded in the electronic apparatus 100′ may be implemented as at least one of volatile memory (e.g., dynamic RAM (DRAM), static RAM (SRAM) or synchronous dynamic RAM (SDRAM), and the like) or non-volatile memory (e.g., one time programmable ROM (OTPROM), programmable ROM (PROM), erasable and programmable ROM (EPROM), electrically erasable and programmable ROM (EEPROM), mask ROM, flash ROM, flash memory (e.g., NAND flash or NOR flash, and the like), hard drive, or solid state drive (SSD)). Additionally, the memory detachable from the electronic apparatus 100′ may be implemented in the form of a memory card (e.g., a compact flash (CF), secure digital (SD), micro secure digital (Micro-SD), mini secure digital (Mini-SD), extreme digital (xD), a multi-media card (MMC), and the like), external memory (e.g., USB memory) connectable to a USB port, or the like.

The display 160 may be implemented as a display including a self light emitting element, or a display including a non-self light emitting element and backlight. For example, the display 160 may be implemented as various types of displays such as a liquid crystal display (LCD), an organic light emitting diode (OLED) display, a light emitting diode (LED), a micro LED, a mini LED, a plasma display panel (PDP), a quantum dot (QD) display, a quantum dot light-emitting diode and the like. In the display 160, driving circuitry implementable in the form of an a-si TFT, a low temperature poly silicon (LTPS) TFT, an organic TFT (OTFT) and the like, a backlight unit and the like may be included together. Meanwhile, the display 160 may be implemented as a touch screen coupled with a touch sensor, a flexible display, a rollable display, a 3D display, a display in which a plurality of display modules is physically connected, and the like. The processor 140 may control the display 160 to output an output image obtained according to the above-described embodiments. Herein, the output image may be an image of high resolution greater than or equal to 4K or 8K. The output image may also be a game image according to one embodiment.

According to another embodiment, the display 160 may include a plurality of haptic elements. The haptic elements may be implemented as a motor for providing a haptic feedback (e.g., a vibration feedback) to the user, but not limited thereto. As one example, the display 160 may include a predetermined number of haptic elements. In another example, the display 160 may include a predetermined number of haptic elements corresponding to a predetermined number of sub areas of the display, but not be limited thereto, and certainly, the display may include haptic elements of a number different from the number of a plurality of sub areas corresponding to the display.

The at least one sensor 170 (hereafter, a sensor) may include a plurality of sensors of various types. The sensor 170 may measure a physical amount or sense an operation state of the electronic apparatus 100′, and convert the measured or sensed information into an electric signal. The sensor 170 may include a camera, and the camera may include a lens that focuses, to an image sensor, visible light or other optical signals received by reflecting from an object, and an image sensor that senses visible light or other optical signals. The image sensor may include a 2D pixel array that is divided into a plurality of pixels. Alternatively, the at least one sensor 170 may include a temperature sensor or an infrared sensor.

The user interface 180 is an element for performing an interaction of the electronic apparatus 100′ with the user. For example, the user interface 180 may include at least one of a touch sensor, a motion sensor, a button, a jog, a dial, a switch, a microphone or a speaker, but not be limited thereto.

The communication interface 190 may input and output various types of data. For example, the communication interface 190 may transceive various types of data with an external device (e.g., a source device), an external storage medium (e.g., USB memory), an external server (e.g., a webhard) based on a communication method such as AP-based Wi-Fi (Wi-Fi, Wireless LAN Network), Bluetooth, Zigbee, wired/wireless Local Area Network (LAN), Wide Area Network (WAN), Ethernet, IEEE 1394, High-Definition Multimedia Interface (HDMI), Universal Serial Bus (USB), Mobile High-Definition Link (MHL), Audio Engineering Society/European Broadcasting Union (AES/EBU), Optical, Coaxial and the like.

As an example, the communication interface 190 may include a Bluetooth Low Energy (BLE) module. The BLE means a Bluetooth technology enabling transmission and reception of low-power low-capacity data in a 2.4-GHz frequency band having a reach radius of about 10 m. However, the communication interface 190 may not be limited thereto, and may also include a Wi-Fi communication module. That is, the communication interface 190 may include at least one of a Bluetooth Low Energy (BLE) module or a Wi-Fi communication module.

The electronic apparatus 100′ may change a filter value adaptively even with a low resource, by using the feedforward ANC model including the feedforward filter implemented as a fixed filter and the gain adaptive filter.

Meanwhile, the methods, according to the embodiments described above, may be implemented in the form of an application that is installable in an existing electronic apparatus. Alternatively, the methods, according to the embodiments described above, may be performed by using a trained neural network based on deep learning (or a deeply trained neural network), i.e., a trained network model. Additionally, the methods, according to the embodiments described above, may be implemented only based on an upgrade of software or hardware of an existing electronic apparatus. The embodiments described above may be performed through an embedded server provided in an electronic apparatus or an external server of an electronic apparatus.

The embodiments described above may be implemented with software including instructions stored in a storage medium readable by a machine (e.g., a computer). The machine, as a device capable of calling stored instructions from the storage media and operating according to the called instructions, may include a display device (e.g., display device A) according to the disclosed embodiments. Based on the instructions being executed by a processor, the processor may perform functions corresponding to the instructions directly or by using other elements under the control of the processor. The instructions may include a code provided or executed by a compiler or an interpreter. The machine-readable storage medium may be provided in the form of a non-transitory storage medium. Herein, the term “non-transitory” means that the storage medium does not include a signal and only means that the storage medium is tangible, while the term does not differentiate semi-permanent or temporary storage of data in the storage medium.

According to the embodiments, the method may be provided in a computer program product. The computer program product may be exchanged between a seller and a purchaser as a commodity. The computer program product may be distributed in the form of a machine-readable storage medium (e.g., compact disc read only memory (CD-ROM)) or distributed online through an application store (e.g., Play Store™). In the case of online distribution, at least part of the computer program product may be stored at least temporarily, or provided temporarily in a storage medium such as a manufacturer's server, a server of an application store, or memory of a relay server.

Each of the elements (e.g., a module or a program) according to the embodiments described above may be comprised of a single entity or a plurality of entities, and some of the corresponding sub elements described above may be omitted, or another sub element may be further included in the embodiments. Alternatively or additionally, some of the elements (e.g., modules or programs) may be integrated into one entity to perform functions performed by each corresponding element prior to integration in an identical or similar manner. Operations performed by a module, a program, or another element, according to the embodiments, may be executed sequentially, in parallel, repetitively, or heuristically, or at least some of the operations may be executed in a different order, omitted, or may include another operation.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic apparatus comprising:
a speaker;
an outer microphone disposed in a direction opposite to a direction in which the speaker releases a sound;
an inner microphone disposed in a direction in which the speaker releases a sound;
memory, comprising one or more storage media, storing instructions; and
one or more processors communicatively coupled to the speaker, the outer microphone, the inner microphone, and the memory,
wherein the instructions, when executed by the one or more processors individually or collectively, cause the electronic apparatus to:
identify a noise signal based on an audio signal obtained through the inner microphone,
input, to a first filter including a gain adaptation filter, a first audio signal obtained through the outer microphone, to identify a cancellation sound signal having a wavelength opposite to a wavelength of the identified noise signal;
identify a first response characteristic and a second response characteristic corresponding to characteristics between the speaker and the inner microphone;
input an error signal identified based on the identified noise signal and the identified cancellation sound signal to an adaptive module;
update a coefficient of the gain adaptation filter based on the adaptive module excluding the second response characteristic; and
control the speaker to output the identified cancellation sound signal.

2. The electronic apparatus of claim 1,
wherein the first filter further includes a feedforward filter having a fixed coefficient, and
wherein the instructions, when executed by the one or more processors individually or collectively, further cause the electronic apparatus to:
input the first audio signal to the feedforward filter to identify a first signal,
identify an estimated second response characteristic corresponding to the second response characteristic,
update the coefficient of the gain adaptation filter based on the identified first signal and the identified error signal, excluding the estimated second response characteristic, and
identify the cancellation sound signal based on the gain adaptation filter of which a coefficient is updated.

3. The electronic apparatus of claim 2, wherein the coefficient of the gain adaptation filter is updated based on a parameter within a predetermined range and a function of a predetermined type.

4. The electronic apparatus of claim 2, further including:
a third filter outputting a signal within a predetermined first frequency band,
wherein the instructions, when executed by the one or more processors individually or collectively, further cause the electronic apparatus to:
input the identified first signal to the third filter to identify an updated first signal, and
update the coefficient of the gain adaptation filter based on the updated first signal, the second response characteristic and the identified error signal.

5. The electronic apparatus of claim 4, wherein the instructions, when executed by the one or more processors individually or collectively, further cause the electronic apparatus to:
update, based on an estimated frequency band of the noise being identified according to the first audio signal, the third filter in accordance with the identified estimated frequency band; and
input the identified first signal to the updated third filter to identify the updated first signal.

6. The electronic apparatus of claim 4, wherein the third filter is implemented as a band pass filter or a low pass filter.

7. The electronic apparatus of claim 1, wherein the instructions, when executed by the one or more processors individually or collectively, further cause the electronic apparatus to:
identify whether a user utterance is made based on the first audio signal and the identified error signal; and
identify, based on the user utterance being identified, the cancellation sound signal based on a filter excluding the gain adaptation filter out of the first filter.

8. The electronic apparatus of claim 7, further including:
a fourth filter compensating an input signal and a fifth filter outputting a signal within a predetermined second frequency band,
wherein the instructions, when executed by the one or more processors individually or collectively, further cause the electronic apparatus to:
input the identified error signal to the fourth filter to identify an undated error signal,
input the first audio signal to the fifth filter to identify an updated first audio signal, and
identify whether a user utterance is made based on the updated first audio signal and the updated error signal.

9. The electronic apparatus of claim 1, wherein the instructions, when executed by the one more processors individually or collectively, further cause the electronic apparatus to:
control the speaker to output a content sound signal corresponding to a sound source content and the identified cancellation sound signal together.

10. A method of controlling an electronic apparatus, the method comprising:
identifying a noise signal based on an audio signal obtained through an inner microphone disposed in a direction in which a speaker releases a sound;
inputting, to a first filter including a gain adaptation filter, a first audio signal obtained through an outer microphone disposed in a direction opposite to a direction in which the speaker releases a sound, to identify a cancellation sound signal having a wavelength opposite to a wavelength of the identified noise signal;
identifying a first response characteristic and a second response characteristic corresponding to characteristics between the speaker and the inner microphone;
inputting an error signal identified based on the identified noise signal and the identified cancellation sound signal to an adaptive module;
updating a coefficient of the gain adaptation filter based on the adaptive module excluding the second response characteristic; and
controlling a speaker to output the identified cancellation sound signal.

11. The method of claim 10,
wherein the first filter further includes a feedforward filter having a fixed coefficient,
wherein the updating of the coefficient includes:
inputting the first audio signal to the feedforward filter to identify a first signal, and
updating the coefficient of the gain adaptation filter based on the identified first signal, a second response characteristic corresponding to a characteristic between the speaker and the inner microphone and the identified error signal, and
wherein the identifying of the cancellation sound signal includes identifying the cancellation sound signal based on the gain adaptation filter of which a coefficient is updated.

12. The method of claim 11, wherein the coefficient of the gain adaptation filter is updated based on a parameter within a predetermined range and a function of a predetermined type.

13. The method of claim 11,
wherein the electronic apparatus further includes a third filter outputting a signal within a predetermined first frequency band,
wherein the method further includes inputting the identified first signal to the third filter to identify an updated first signal, and
wherein the updating of the coefficient includes updating the coefficient of the gain adaptation filter based on the updated first signal, the second response characteristic and the identified error signal.

14. The method of claim 13, further including:
updating, based on an estimated frequency band of the noise being identified according to the first audio signal, the third filter in accordance with the identified estimated frequency band,
wherein the identifying of the updated first signal includes inputting the identified first signal to the updated third filter to identify the updated first signal.

15. The method of claim 13, wherein the third filter is implemented as a band pass filter or a low pass filter.

16. The method of claim 10, further including:
identifying whether a user utterance is made based on the first audio signal and the identified error signal; and
identifying, based on the user utterance being identified, the cancellation sound signal based on a filter excluding the gain adaptation filter out of the first filter.

17. The method of claim 16,
wherein the electronic apparatus further includes a fourth filter compensating an input signal, and a fifth filter outputting a signal within a predetermined second frequency band, and
wherein the method further includes:
inputting the identified error signal to the fourth filter to identify an undated error signal,
inputting the first audio signal to the fifth filter to identify an updated first audio signal, and
identifying whether a user utterance is made based on the updated first audio signal and the updated error signal.

18. The method of claim 10, further including:
controlling the speaker to output a content sound signal corresponding to a sound source content and the identified cancellation sound signal together.

19. One or more non-transitory computer-readable storage media storing one or more computer including computer-executable instructions that, when executed by one or more processors of an electronic apparatus individually or collectively, cause the electronic apparatus to perform operations, the operations comprising:
identifying a noise signal based on an audio signal obtained through an inner microphone disposed in a direction in which a speaker releases a sound;
inputting, to a first filter including a gain adaptation filter, a first audio signal obtained through an outer microphone disposed in a direction opposite to a direction in which the speaker releases a sound, to identify a cancellation sound signal having a wavelength opposite to a wavelength of the identified noise signal;
identifying a first response characteristic and a second response characteristic corresponding to characteristics between the speaker and the inner microphone;
inputting an error signal identified based on the identified noise signal and the identified cancellation sound signal to an adaptive module;
updating a coefficient of the gain adaptation filter based on the adaptive module excluding the second response characteristic; and
controlling a speaker to output the identified cancellation sound signal.

20. The one or more non-transitory computer-readable storage media of claim 19, wherein the operations further comprising:
inputting the first audio signal to a feedforward filter, having a fixed coefficient, to identify a first signal,
identifying an estimated second response characteristic corresponding to the second response characteristic,
updating the coefficient of the gain adaptation filter based on the identified first signal and the identified error signal, excluding the estimated second response characteristic, and
identifying the cancellation sound signal based on the gain adaptation filter of which a coefficient is updated.
